(19) United States
(12) Patent Application Publication
(10) Pub. No.: US 2012/0020535 A1
(43) Pub. Date: Jan. 26, 2012

(54) Unique, repeatable, and compact biometric identifier

(75) Inventor: Nikolai N. Liachenko, Northridge, CA (US)

(73) Assignee: Igentx

(21) Appl. No.: 12/804,492

(22) Filed: Jul. 22, 2010

(51) Int. Cl. G06K 9/00

(52) U.S. Cl. 382/125

(57) ABSTRACT

A biometric processing system. The inventive system implements a novel algorithm for extracting a unique and repeatable code from a biometric image that includes acquiring a biometric image; detecting prominent features in the image; extracting a working area from the image for each detected prominent feature, wherein each working area is a portion of the image around the prominent feature; computing a plurality of parameters for each working area; and encoding the parameters to form an output code. In an illustrative embodiment for fingerprint identification, the prominent features are singularities, and the system defines a local reference system for each working area that is based on the location and orientation of the singularities. Topologically stable points such as minutiae are detected for each working area, and several parameters are then computed for each minutia relative to the local reference system.

### BACKGROUND OF THE INVENTION

1. Field of the Invention

The present invention relates to signal processing systems. More specifically, the present invention relates to systems and methods for biometric identification.

2. Description of the Related Art

Biometric identification systems are commonly used in a variety of security applications to identify an individual based on intrinsic physical features such as fingerprints, palm prints, or iris scans. These systems typically acquire and then analyze an image of the biometric feature (e.g., a scan of the fingertip, palm, or iris). A difficulty in biometric identification is the variability in the acquired images. Different scans taken of the same feature are rarely, if ever, identical. For example, the position and rotation of the finger, skin conditions (such as dry skin), and the amount of pressure exerted by the finger during fingerprint acquisition all affect the acquired fingerprint image. Conventional identification systems therefore usually require a comparison or matching function that computes the similarity of the biometric image with a previously acquired image.

Security systems for controlling access to a particular location, data, or equipment typically acquire biometric images of authorized individuals during an enrollment process. Image acquisition is usually accomplished using an optical scanner, specialized photo-camera, or similar device. The system measures a plurality of parameters in the acquired enrollment image and encodes these parameters in a special format called a template. These templates are then stored in a database for future comparison during the identification or verification process.

Currently, the prevailing direction in biometric identification is based on a search for special features in the biometric image or on special transformations (e.g., “wavelet” transformations) carrying information about important low-level details of the image. Fingerprint and palm print identification systems, for example, typically focus on points called minutiae, which include termination points (the abrupt end of a ridge) and bifurcation points (where a single ridge divides into two ridges, e.g. a fork). A list of the minutiae found in an image, including their types, locations, and orientations, are stored in the biometric template. These parameters will clearly vary over different scans of the same finger or palm, since locations and orientations of minutiae are dependent on the positioning of the finger or palm during acquisition. Iris recognition systems typically use transformations applied to the acquired image, representing the image as a combination of some standard function with weight coefficients. These coefficients are then used to form the biometric template.

During the actual identification process, an individual attempting to access the system goes through the image capturing stage, for example, submitting a finger, palm, or iris for scanning. The identification system analyzes the acquired biometric image to generate a template. This template is then compared with the previously acquired enrollment templates stored in the database. Templates from different scans of the same feature are generally not identical, so a correlation or similarity score must be computed for each template to search for a match. The nearest similar template in the database is considered a match if the degree of resemblance is higher than a certain predetermined threshold. The individual is then identified as the identity associated with the matching template in the database.

There are several weaknesses with this match-based approach. Since extracted templates are different from scan to scan of the same feature, a comparison search is needed for identification. The template itself cannot be used for immediate identification. The comparison search process can be complex and time consuming, particularly when searching a large database. Further, the database is often remote from the point of access, requiring sensitive biometric data to be sent via some communication network, presenting an additional security concern.

Attempts have been made to find repeatable features that can be extracted from biometric images that are the same across different scans of the same feature. Unfortunately, such repeatable features generally are not unique, meaning that scans from different individuals can produce the same results. These types of features are therefore typically used for indexing or classification purposes to help narrow a database search, but they cannot be used alone for identification.

Hence, a need remains in the art for an improved biometric identification system or method that can extract features that are both repeatable and unique.

### SUMMARY OF THE INVENTION

The need in the art is addressed by the biometric processing system of the present invention. The inventive system implements a novel algorithm for extracting a unique and repeatable code from a biometric image that includes acquiring a biometric image; detecting prominent features in the image; extracting a working area from the image for each detected prominent feature, wherein each working area is a portion of the image around the prominent feature; computing a plurality of parameters for each working area; and encoding the parameters to form an output code. In particular, the system detects topologically stable points in each working area and defines a local reference system for each working area that is based on the location and orientation of the prominent feature. Several parameters for each stable point are then computed relative to the local reference system.

In an illustrative embodiment for fingerprint identification, the prominent features are singularities, and the system defines a local reference system for each working area that is based on the location and orientation of the singularities. Minutiae are detected for each working area, and several parameters are computed for each minutia, including the quadrant and rotation of the minutia relative to the local reference system and a crossing index that measures the number of ridge loops between the minutia and the center of the singularity. The novel algorithm also defines and encodes graph edges in each working area, represented by pairs of minutiae that are connected by ridges.

### BRIEF DESCRIPTION OF THE DRAWINGS

FIG. 1 is a simplified block diagram of a conventional fingerprint identification system.

FIG. 2 is a simplified block diagram of a fingerprint identification system in accordance with an illustrative embodiment of the present teachings.

FIG. 3 is simplified block diagram of a fingerprint identification device in accordance with an illustrative embodiment of the present teachings.

FIG. 4 is a simplified flow chart of a fingerprint ID generation algorithm in accordance with an illustrative embodiment of the present teachings.

FIG. 5a is an example fingerprint of the “tented arch” type.

FIG. 5b is an example fingerprint of the “plain arch” type.

FIG. 6 is an example fingerprint having three singularities, showing the three associated working areas extracted in accordance with the present teachings.

FIG. 7 is an example skeletonized working area showing an illustrative local coordinate system and zones in accordance with the present teachings.

FIG. 8 is a simplified diagram showing the structure of the biometric code in accordance with an illustrative embodiment of the present teachings.

FIG. 9a is an example fingerprint having two adjacent loop singularities.

FIG. 9b is an example fingerprint having two loop singularities that form a core.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

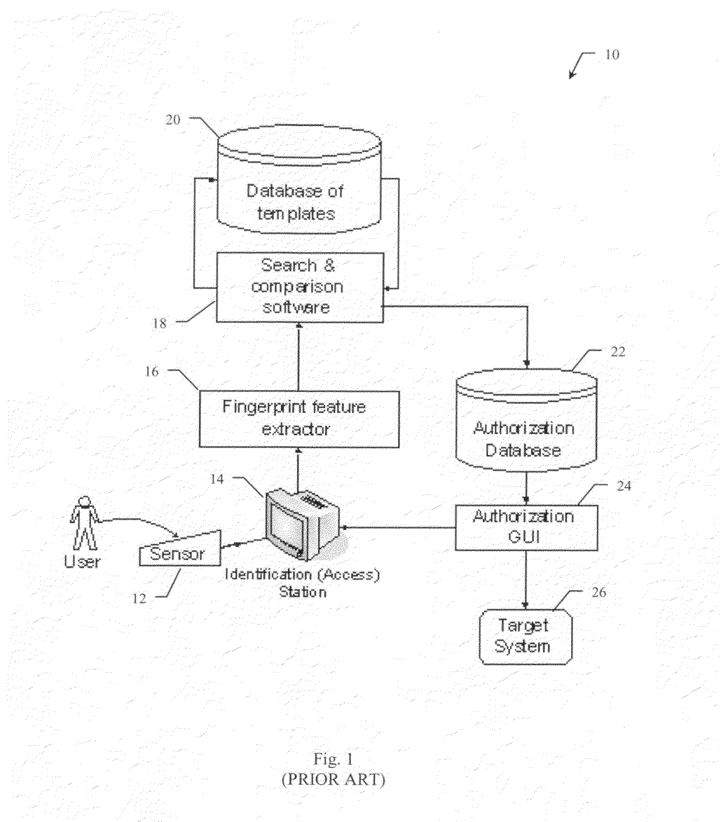

FIG. 1 is a simplified block diagram of a conventional fingerprint identification system 10. The process starts with a user submitting a finger to a sensor 12, which is typically an optical scanner that generates a grayscale fingerprint image from the finger. The fingerprint image is input to a computer 14, which includes a feature extractor algorithm 16 that extracts a plurality of features, typically minutiae, from the image. Characteristics of the extracted features—including, for example, the type (termination or bifurcation), location (x,y coordinates), and orientation (angle of the ridge line at the minutia point relative to the horizontal axis) of each minutia—are then stored in a standard format called a fingerprint template. These features are not repeatable since different scans are typically produced with the finger having a different location, rotation, pressure, etc. on the scanner. Different scans of the same finger will therefore result in different extracted features, which results in different templates.

Non-repeatability leads to a need for a comparison or matching function. Conventional fingerprint identification systems therefore typically include comparison software 18, which compares the acquired fingerprint template with previously acquired templates stored in a database 20. For each stored template, the comparison software 18 computes a match score that represents the likelihood of a match (probability that the two compared templates were produced from the same finger). The stored template having the highest score that is above some predetermined threshold is then considered a match, and the user is identified as the individual associated with the matching template. An authorization system 24 can then search for the extracted identity in an authorization database 22 and allow or deny access to the target system 26 accordingly.

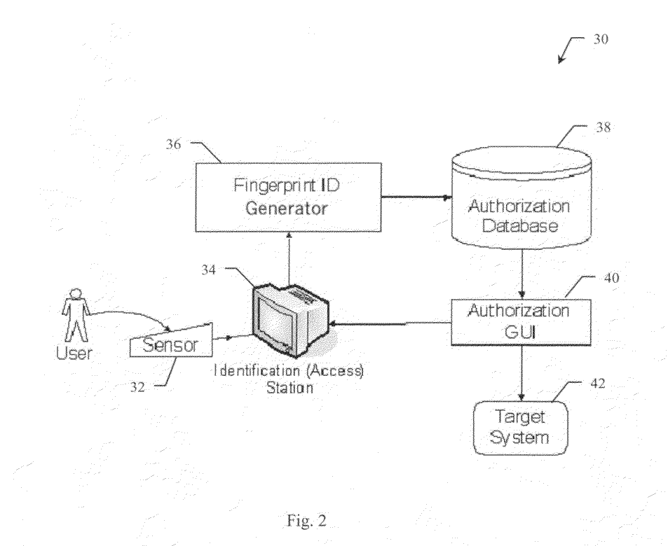

In contrast, the present invention eliminates the need for template comparison by extracting a code directly from a fingerprint scan that is both unique and repeatable. FIG. 2 is a simplified block diagram of a fingerprint identification system 30 in accordance with an illustrative embodiment of the present teachings. The user submits a finger to a sensor 32, which may be an optical scanner that generates a grayscale fingerprint image. Other fingerprint acquisition systems such as solid-state fingerprint readers may also be used to acquire the fingerprint image. The image is input to a computer 34 or other type of processor, which includes a novel fingerprint ID generator 36.

The ID generator 36 analyzes the fingerprint scan and generates a short (about 20 characters long) alphanumeric code that is unique to the finger and repeatable over a broad scope of finger positioning and pressure during different scans of the same finger. This ID code can then be sent directly to the authorization system 40, which searches for the code in an authorization database 38 (that contains the previously extracted ID codes of authorized individuals) and then grants or denies access to the target system 42.

Thus, under this architecture, there is no need for template comparisons or similarity computations to establish the identity of the user. The fingerprint scan alone is sufficient to extract a code that is uniquely associated with the user during the enrollment process.

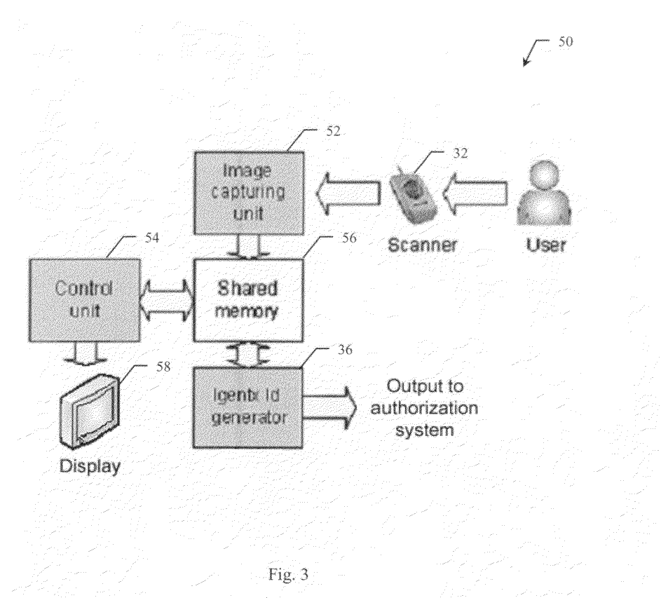

FIG. 3 is simplified block diagram of a fingerprint identification device 50 in accordance with an illustrative embodiment of the present teachings. The device 50 includes a scanner 32, an image capturing unit 52, a control unit 54, a fingerprint ID generator 36, a memory 56, and a display 58. The image capturing unit 52 interacts with the scanning hardware 32 and outputs a grayscale image containing the scanned fingerprint. The image is stored in the shared memory 56 reserved for information exchange between modules. The control unit 54 verifies that the capturing step has been performed and transfers control the fingerprint ID generator 36, which performs the computation steps of the ID generation algorithm of the present invention. The control unit 54 has the ability to receive messages about intermediate results of the computation and optionally can display those results on the display 58. The output code (or a failure message) generated by the ID generator 46 is then output to the authorization system.

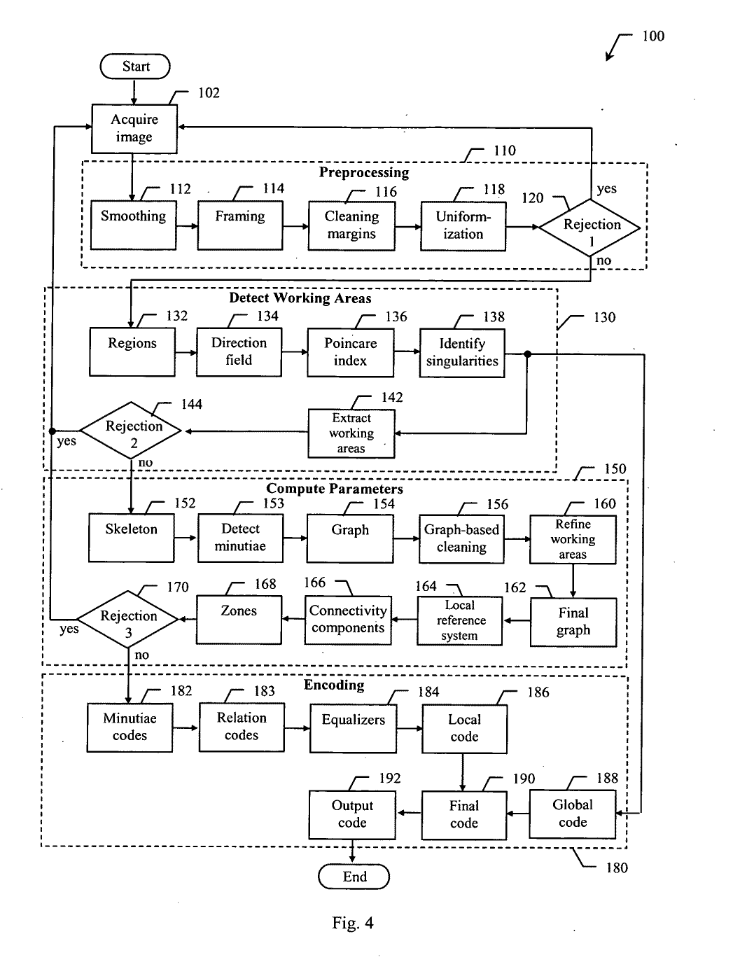

FIG. 4 is a simplified flow chart of the fingerprint ID generation algorithm 100 in accordance with an illustrative embodiment of the present teachings. In the illustrative embodiment, the fingerprint ID generation system 100 is a software algorithm stored in memory and executed by a computer or specialized processor. For improved performance, the systems and functions described can also be implemented in hardware using, for example, discrete logic circuits, FPGAs, ASICs, etc. Other implementations may also be used without departing from the scope of the present teachings.

The algorithm begins at Step 102, acquiring the fingerprint image (from the scanner or other similar device) and loading the image to the processor.

Next is the preprocessing stage 110, which involves manipulating the raw image from the scanner to obtain the best possible fingerprint image for the subsequent analysis. For example, as shown in FIG. 4, preprocessing 110 may include the following functions: an image smoothing function 112 for removing noise from sources such as dust or scanner imperfections; a framing function 114 for cropping the image to the area containing the fingerprint (since the scanning area is typically larger than the fingerprint); a cleaning margins function 116 for removing any random spots in the corners of the cropped image (which should be empty since a fingerprint has an oval shape while the image is typically rectangular); and a uniformization function 118 that changes the intensity of each pixel of the image to a value proportional to the rank of this intensity in a window around that pixel (adjusting the image contrast to correct for uneven contrast).

After the preprocessing functions are performed, a first rejection rule 120 is applied. This function analyzes the image to determine if the quality of the image after preprocessing is insufficient for the subsequent processing steps. If so, then the rejection stage 120 generates a message for the user (via a display or other user interface) to resubmit the finger for scanning, and the system 100 acquires a new fingerprint image (returns to Step 102). The image is rejected if a fingerprint was not captured (the image is almost all white), or if the submission of the finger appears to deviate too much from normal position, angle, and degree of pressure. In a preferred embodiment, if the image is rejected, the rejection stage 120 generates a message to the user with advice on how to resubmit the finger. For example, if the fingerprint is too close to the left edge of the image, cutting off part of the fingerprint, the user is instructed to rescan the finger after moving the finger slightly to the right.

If the rejection stage 120 determines that image quality is sufficient, then the process 100 continues to the “detect working areas” stage 130. In accordance with the present teachings, the algorithm 100 searches for and extracts special portions of the image (called “working areas”) for which local reference systems can be reliably established. In particular, the system searches for prominent features in the image that can be reliably detected. A working area centered around each detected feature is then cropped from the image. The subsequent processing is performed on these working areas. For fingerprint identification, the working areas are portions of the image centered around singularities.

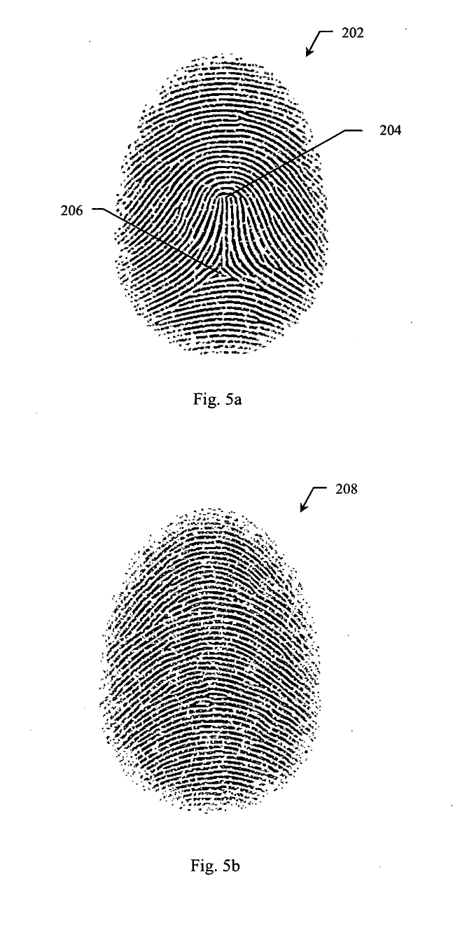

Singularities are regions in a fingerprint where the ridges form a distinctive shape characterized by high curvature. A singularity is usually one of three types: loop, delta, or whorl. Fingerprints typically include one to four singularities. See FIG. 5a, for example, which shows an example “tented arch” type fingerprint 202 that includes two singularities: a loop type singularity 204 and a delta type singularity 206. It is very rare for a fingerprint to have more than four singularities. Some fingerprints, called “arch” or “plain arch” type prints, do not include any loop, whorl, or delta type singularities. See FIG. 5b, which shows an example plain arch type fingerprint 208. The point of highest ridge curvature in the print may be considered the “singularity” for these types of fingerprints. As used herein, the term singularity includes the traditional loop, delta, and whorl singularities, as well as the center of maximal ridge curvature in arch type fingerprints.

Several algorithms are known in the art which can reliably detect singularities. For example, in the illustrative embodiment of FIG. 4, singularities are found using the well-known Poincare index. First, at Step 132, the image is subdivided into a grid of small square regions, and at Step 134, the local ridge orientation of each region is computed, forming a direction field or orientation map of the image (a matrix M_{i,j} whose elements correspond to the local orientation of the fingerprint ridges).

At Step 136, the Poincare index for each region (i,j) is computed by summing the change in orientation between adjacent elements (in the orientation map) around a closed path surrounding the region (i,j), such as the eight neighboring elements. At Step 138, singularities are identified based on the Poincare computations. Regions without a singularity will return a Poincare index of 0°. A Poincare index of 360° indicates that the region includes a whorl type singularity, while a Poincare index of 180° indicates a loop type singularity, and Poincare index of −180° indicates a delta type singularity. Thus, using the Poincare calculations, the function 138 determines the number of singularities in the fingerprint, as well as their types and estimated locations. Other methods for detecting singularities as well as methods for removal of false candidates to singularities occasionally produced by the Poincare procedure may also be used without departing form the scope of the present teachings.

If the fingerprint is an arch type image (as shown in FIG. 5b), the Poincare index will not return any singularities. In this case, the algorithm finds the region of maximal ridge curvature in the direction field 134. The center of this region is considered the singularity for this type of fingerprint.

Next, at Step 142, a working area of predetermined size around each singularity is extracted from the fingerprint image for further analysis. A working area is defined as a small portion of the image centered over a singularity. The size of the working area is chosen such that the area includes enough features for unique identification, but is small enough to preserve stability. The optimal working area size may be determined experimentally. In the illustrative embodiment, each working area is an approximately 0.2 inch square region (100×100 pixels for a 500 dpi scan). A working area is extracted from the image for each singularity found in Step 138.

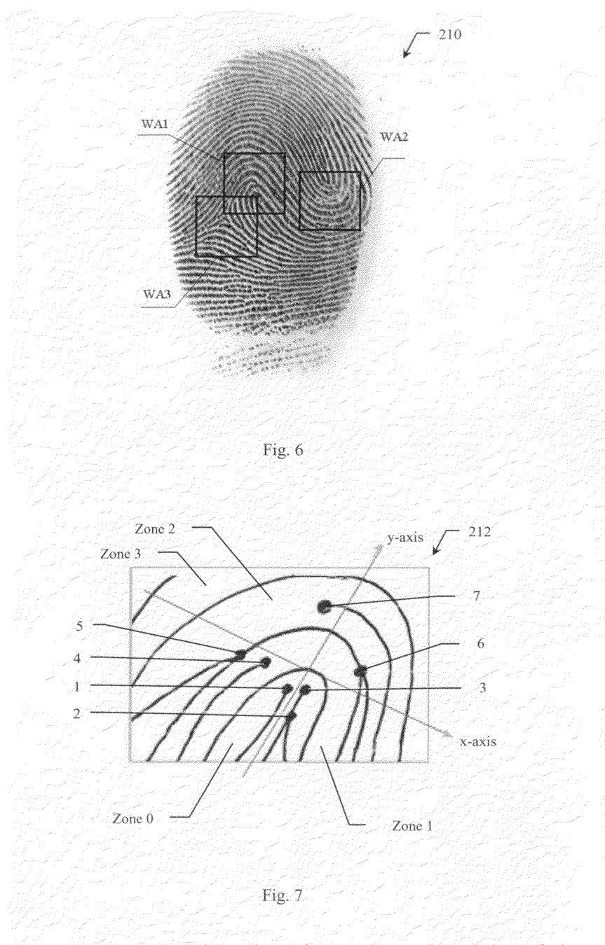

FIG. 6 shows an example fingerprint image 210 having three singularities (two loops and one delta) and the three associated working areas, labeled WA1, WA2, and WA3, extracted in accordance with the present teachings. The purpose of the working areas is to reduce the analysis of the low-level details of the image to a smaller portion (especially to remove non-informative marginal areas from the analysis), and also to reduce dependence of the selected fragments on the initial finger positioning.

Conventional fingerprint identification approaches tend to avoid focusing on the areas around singularities since these have traditionally been considered the most difficult to analyze. The present invention, however, focuses primarily on these regions because singularities are relatively easy to detect reliably and accurately as compared with other features.

If a singularity is too close to the edge of the image, a working area of the predetermined size cannot be extracted. At Step 144, a second rejection stage is applied that rejects the scan if working areas cannot be extracted, or if the detected singularities are abnormal (for example, if too many singularities found). If any problems are detected, the image is rejected. A message is generated asking the user to rescan the finger (preferably with advice on how to resubmit the finger to correct the problem) and the algorithm 100 returns to Step 102 to acquire a new image.

If no problems are detected at Step 144, then the process 100 continues to the compute parameters stage 150, which extracts a plurality of parameters for each working area. In particular, the system defines a local reference system for each working area and detects topologically stable points such as minutiae (termination and bifurcation points). A plurality of parameters is measured for each minutia point, plus parameters that characterize the structure of the working areas (such as graph edges and zones, described below). These parameters are later encoded in the final encoding stage 180.

First, at Step 152, a skeletonized version of each working area is constructed. As is well known in the art, a skeleton image is a version of the fingerprint image after binarization, which converts the image to only black (ridge) and white (not ridge) pixels, and thinning, which converts ridge lines to a uniform thickness (typically one pixel thick). Various methods are known in the art for obtaining a skeleton image, and any of these methods may be applied to a working area to obtain a skeletonized working area.

At Step 153, the system searches for topologically stable points in each skeletonized working area. In the illustrative embodiment, the stable points are minutiae, including termination and bifurcation points in the ridges. At Step 153, the system detects the locations of the minutiae in each working area, as well as the type (termination or bifurcation) and orientation (the direction of the ending of a termination or of the merging of a bifurcation) of each minutia. Methods for detecting minutiae are well known in the art, and any suitable detection algorithm may be used. Termination points near the edges of the working area are not included among the minutiae (since these points are usually artificial minutiae caused by cropping the image to form the working area).

At Step 154, a ridge graph is constructed for each working area. In the field of graph theory, a graph is comprised of a plurality of vertices and a plurality of edges that connect selected pairs of vertices. In accordance with the present teachings, a graph is constructed for each working area with the detected minutiae as vertices of the graph, and pairs of vertices being connecting with an edge if their corresponding minutiae are connected by a ridge in the skeleton image.

At Step 156, graph-based cleaning is applied to the graphs of each skeletonized working area to preserve connectivity. The skeleton image may include spurs, small isolated ridges, and small breaks in the ridges (generating false termination points) due to the thinning process or to scanning. The graph-based cleaning function 156 removes spurs and small ridges. It also searches the skeleton image for areas that look like an artificial break in connectivity (a small gap in an otherwise continuous line) and fills in the gaps to connect the ridges (removing any false minutiae). In a preferred embodiment, these corrections to the skeleton are performed as fast and simple graph operations rather than actual manipulation of the skeleton image (hence the term “graph-based” cleaning).

Next, at Step 160, the working areas are refined. The working areas found in Step 142 were based on the singularities found in Step 138, which gave an estimated location of the singularities. The center of a singularity can be determined more accurately using the graphs. Thus, in Step 160, the center of each singularity is computed from the skeletonized working areas and graphs, and new working areas are obtained centered around the newly computed singularity centers. In a preferred embodiment, the size of the refined working area is smaller than the original working area, such that the entire refined working area is contained within the original working area. For example, if a 500 dpi image had an original working area of 121×121 pixels, the refined working area might be 97×97 pixels. This way, at Step 162, a final graph for each refined working area can be constructed by simply cropping the previously obtained graphs (rather than recalculating Steps 152-158).

At Step 164, a local reference system is found for each working area. Since the actual coordinate system of the working area is dependent on the position and orientation of the finger during scanning, encoding the coordinates of the minutiae would result in different codes for different scans. The present invention therefore defines a local coordinate system (local to each working area) that is based on the ridge pattern instead of the arbitrary scanned image coordinates. Any coordinate system can be used that is invariant across different scans. In the illustrative embodiment, the local coordinate system is defined as having an origin located at the center of the singularity and a y-axis that coincides with an orientation of the singularity (the direction of highest curvature). See FIG. 7, which shows an illustrative skeletonized working area 212 with a local coordinate system (x-axis and y-axis) in accordance with the present teachings.

FIG. 7 also shows the minutiae (labeled 1, 2, 3, 4, 5, 6, and 7) found in the illustrative working area 212. The locations of the minutiae are then determined relative to the local coordinate system. In a preferred embodiment, the locations of the minutiae are based on a “rough” scale, which registers only the quadrant of the minutia location relative to the local system. This makes the parameters more stable as compared to measuring the actual coordinate values. In rare cases (depending on the accuracy with which the local system is defined), the quadrant may be determined erroneously. Such errors may be compensated by “equalizers” discussed later in the text. In a preferred embodiment, the system also determines the rotation of each minutia relative to the local reference system (the clockwise or counterclockwise direction of the ending of a termination or of the fork merging of a bifurcation). Minutiae within the innermost ridge loop (e.g., minutiae 1, 2, and 3 in the example of FIG. 7) are considered to have zero rotation.

Thus, the minutiae parameters are computed in a way that is approximately invariant of plastic deformation, rotation, and shift. For the purpose of stability, minutiae positions are computed not only relative to the local reference system, but also using a “crossing index” determined by the system of concentric loops, which are characteristic to the loop and whorl type singularities, or by the triangle structure of quasi-hyperbolic curves surrounding delta singularities.

At Step 166, connectivity components are found in each working area. In accordance with the present teachings, a connectivity component is defined as all pixels in the skeletonized working area that are connected (in correspondence with the usual use of the term in graph theory). Each individual ridge plus any ridges connected thereto are therefore considered a connectivity component.

At Step 168, a “crossing index” or “zone” for each minutia is determined for each working area. In accordance with the present teachings, the working area is divided into a plurality of zones by ridge loops, which are connectivity components that have a loop or arch shape. The crossing index of a minutia indicates in which zone the minutia point is located. See FIG. 7, which is an example skeletonized working area 212, showing the different zones (labeled Zone 0, Zone 1, Zone 2, and Zone 3) separated by loop connectivity components. In the illustrative embodiment, the crossing index is determined by counting the number of ridge loops between the minutia point and the center of the singularity. Thus, minutiae located within the innermost loop are in Zone 0. The area between the most internal loop and the second most internal loop is defined as Zone 1, and so forth. Thus, in FIG. 7, minutia points 1, 2, and 3 are in Zone 0; points 4, 5, and 6 are in Zone 1; and point 7 is in Zone 2.

At Step 170, a third rejection stage is applied that rejects the scan if any abnormalities are found. This is the last chance for the system 100 to identify flaws in the biometric input. In the illustrative embodiment, the last rejection stage 170 searches for abnormalities such as too many minutiae or ridges (connectivity components) within the most internal loop (Zone 0) or too high density of termination points per square inch. If any problems are detected, the image is rejected. A message is generated asking the user to rescan the finger (preferably with advice on how to resubmit the finger to correct the problem) and the algorithm 100 returns to Step 102 to acquire a new image. If no problems are detected at Step 170, then the process 100 continues to the final stage: encoding 180.

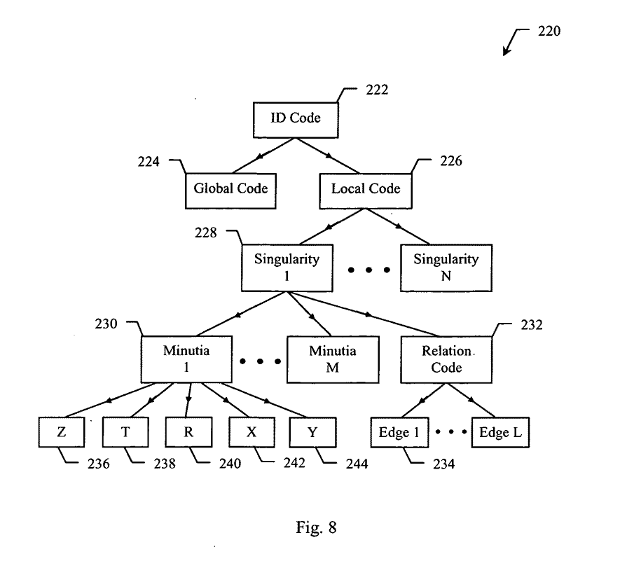

The encoding stage 180 generates a unique and repeatable biometric code from the parameters found in the previous stages. FIG. 8 is a simplified diagram showing the structure 220 of the biometric code 222 in accordance with an illustrative embodiment of the present teachings. The biometric code 222 includes a global code 224, which contains the number of detected singularities and their types and relationships, and a local code 226. The local code 226 includes a code 228 extracted from each working area, i.e., for each detected singularity (labeled Singularity 1 to Singularity N). Each singularity code 228 includes codes 230 for each detected minutiae (labeled Minutia 1 to Minutia M) plus a relation code 232, which represents the relation between minutiae using the connectivity graph edges (labeled Edge 1 to Edge L). Each minutia code 230 includes codes representing each of the minutia parameters: crossing index 236, type 238, rotation 240, x-coordinate 242, and y-coordinate 244.

Returning to FIG. 4, the encoding stage 180 generates and assembles the code segments to form the final code as shown in FIG. 8.

At Step 182, code segments are generated for all minutiae in each working area. In the illustrative embodiment, four parameters are encoded for each minutia: crossing index (as computed in Step 168); type (e.g., ending or fork, as determined in Step 153), rotation direction (as determined in Step 164), and the positioning quadrant relative to the local reference system (determined in Step 164), which includes an x-coordinate (negative or non-negative abscissa) and a y-coordinate (negative or non-negative ordinate).

The following table shows the parameters for all seven minutiae in the example of FIG. 7:

| Minutia # | Zone | Type | Rotation | X | Y |
|---|---|---|---|---|---|
| 1 | 0 | E | 0 | −1 | −1 |
| 2 | 0 | F | 0 | 1 | −1 |
| 3 | 0 | E | 0 | 1 | −1 |
| 4 | 1 | E | −1 | −1 | −1 |
| 5 | 1 | F | −1 | −1 | −1 |
| 6 | 1 | F | 1 | 1 | 1 |
| 7 | 2 | E | 1 | −1 | 1 |

In the table, the minutia type is either E for ending or F for fork; rotation is 0 (no rotation), −1 (clockwise), or +1 (counter-clockwise); x-coordinate is −1 (negative abscissa) or +1 (non-negative abscissa), and y-coordinate is −1 (negative ordinate) or +1 (non-negative ordinate).

At Step 183, a relation code is generated for each working area that lists the sequence of connectivity graph edges. In order to maintain repeatability, a transformation is first applied to each graph that sorts the list of minutiae using some predetermined standard, such that the order of the minutiae is the same across different scans. In the illustrative embodiment, the ordering of minutiae is based on sorting first by zone (crossing index) and then by actual abscissa and ordinate versus ±1 sign values. See the example of FIG. 7, which shows the minutiae ordered in this manner. Other ordering schemes may also be used, as long as the ordering is consistent.

The set of minutiae parameters is sorted in accordance with this order, which also determines the numeration of minutiae. This numeration is then used to encode the edges of the connectivity graph (determined in Steps 154 and 156). The edges are also sorted in the determined order (as pairs of numbers). In the example of FIG. 7, the edges are 2-3 and 5-6 (because minutiae 2 and 3 are connected by a ridge, as are minutiae 5 and 6). This sequence of edges is the relation code for the working area.

Next, at Step 184, “equalizers” are applied to the computed parameters. In accordance with the present teachings, equalizers are transformations found as the result of statistical analysis for mapping different combinations of the computed parameters into the same code to ensure stability of results. In the illustrative embodiment, singularities that are very peripheral are removed, suspicious large gaps in the ridges are filled, and some ends of ridges are equated with forks.

At Step 186, the code segments for each working area, including the minutiae codes and relation codes, are concatenated to form the local code, which is the part of the final code describing the “low-level” graph-based features.

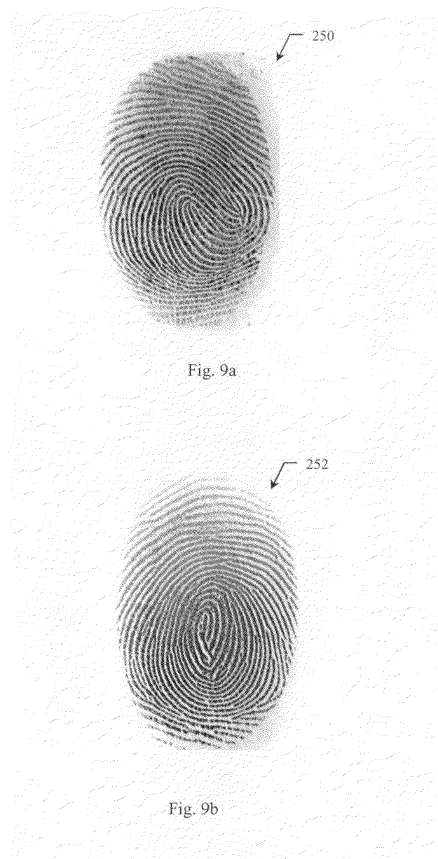

At Step 188, the global code is constructed, which is encoded information about the detected singularities (as found in Step 138). In the illustrative embodiment, the global code includes the number of detected singularities, their types (e.g., L for loop or D for delta), and the relationship between loops if there are two or more loops. For example, if loops are adjacent, then the code D may be used for the case when the left loop is open down or the code U used if it is open up. If the loops form a core, then the code C may be used. FIG. 9a shows an example fingerprint 250 having two adjacent loop singularities, and FIG. 9b shows an example fingerprint 252 having two loop singularities that form a core. Thus, the example of FIG. 9a would have the global code 2LLD, and the example of FIG. 9b would have the global code 2LLC.

At Step 190, the global code and local code are combined to form the final code. In a preferred embodiment, a compression algorithm is applied to the final code to reduce the number of characters in the output. Any suitable compression algorithm may be used. In an illustrative embodiment, during assembly of the final code, all parameters are expressed in binary form and concatenated. The resulting binary code is then expressed in some compression scheme.

Finally, at Step 192, the compressed final code is output from the system.

Thus, a unique code is generated for a fingerprint. Different scans of the same finger should produce the same code since the encoding scheme uses parameters that are invariant to absolute position and rotation of the finger. This is accomplished by focusing feature extraction on small areas (working areas) around each detected singularity, establishing a local coordinate system for each working area that is based on the orientation of the area's singularity, and computing parameters such as crossing index and graph edges that are based on ridge patterns instead of less robust features such as absolute locations, angles, distances, etc., which typically vary over different scans. Additional processes such as graph-based cleaning and equalizers are also used to ensure repeatability.

The repeatable nature of the code generated by the present invention eliminates the search and comparison process required by conventional biometric access systems. A database of templates become unnecessary, and the fingerprint code can be used for access to information and devices in different organizations in a consistent way without any additional effort for integration of these systems. Due to the compact size of the code, it can be used as actual identifiers on documents (medical records, identification cards, barcoded objects, etc.).

The teachings of the present invention may also be applied to other types of biometric systems such as palm print or iris recognition. In the case of palm analysis, the relatively stable working areas can be defined around intersections of the most prominent ridges with the three so-called “principal lines”: heart, head, and life lines. The y-axis for the local reference systems can be chosen along the corresponding principal line.

In the case of iris analysis, the working area could be one ring-shaped iris area and the center of the reference system could be the center of the pupil. The local axes may be determined based on using the eye lid and eye corners, or based on the direction of the highest radial asymmetry of iris ridges in the iris pseudo-texture.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A biometric system comprising:
first means for acquiring a biometric image;
second means for detecting prominent features in said image;
third means for extracting a working area from said image for each detected prominent feature, wherein each working area is a portion of said image around said prominent feature;
fourth means for computing a plurality of parameters for each working area; and
fifth means for encoding said parameters to form an output code.

2. The invention of claim 1 wherein said fourth means includes means for defining a local reference system for each working area based on features in the working area.

2. The invention of claim 2 wherein said local reference system includes an origin located at a center of said prominent feature of said working area and an axis aligned with an orientation of said prominent feature.

4. The invention of claim 2 wherein said fourth means further includes means for detecting stable points in each working area.

5. The invention of claim 4 wherein said parameters include a position of each stable point relative to said local reference system.

6. The invention of claim 5 wherein said position parameter represents the quadrant within which said stable point is located.

7. The invention of claim 4 wherein said parameters include a rotation of each stable point relative to said local reference system.

8. The invention of claim 4 wherein said parameters include a crossing index for each stable point, wherein said crossing index represents within which zone said stable point is located.

9. The invention of claim 8 wherein said zones are based on loop connectivity components in said working area.

10. The invention of claim 9 wherein said crossing index is determined by the number of loop connectivity components between said stable point and a center of said local reference system.

11. The invention of claim 4 wherein said parameters include a relation parameter that represents a structure of said working area.

12. The invention of claim 11 wherein said relation parameter includes a sequence of graph edges in said working area, wherein each graph edge is a pair of stable points that are connected in said image.

13. The invention of claim 4 wherein said prominent features are singularities.

14. The invention of claim 13 wherein said stable points are minutiae.

15. The invention of claim 14 wherein said fourth means includes means for obtaining a graph of each working area, wherein said graph includes a plurality of vertices and a plurality of edges that connect selected pairs of vertices.

16. The invention of claim 15 wherein said minutiae are vertices of said graph, and pairs of vertices are connected with an edge if their corresponding minutiae are connected by a ridge in said image.

17. The invention of claim 15 wherein said fourth means further includes means for refining each said working area based on said graph.

18. The invention of claim 13 wherein said output code also includes a global code that encodes the number, type, and relation of said singularities.

19. The invention of claim 1 wherein said system further includes means for applying equalizers that map different parameter combinations to the same code.

20. The invention of claim 1 wherein said biometric image is a fingerprint.

21. A computer-implemented program for processing a fingerprint comprising:
a function for detecting singularities in a fingerprint image;
a function for, extracting a working area from said image for each detected singularity, wherein each working area is a portion of said image around said singularity;
a function for computing a plurality of parameters for each working area; and
a function for encoding said parameters to form an output code.

22. A biometric system comprising:
a device for acquiring a biometric image;
a processor for analyzing said image;
a memory coupled to said processor; and
a program stored in said memory and executed by said processor, said program including:
a function for detecting prominent features in said image;
a function for extracting a working area from said image for each detected prominent feature, wherein each working area is a portion of said image around said prominent feature;
a function for computing a plurality of parameters for each working area; and
a function for encoding said parameters to form an output code.

23. A method for processing a biometric image including the steps of acquiring a biometric image;
detecting prominent features in said image;
extracting a working area from said image for each detected prominent feature, wherein each working area is a portion of said image around said prominent feature;
computing a plurality of parameters for each working area; and
encoding said parameters to form an output code.
